(19) United States
(12) Patent Application Publication
(10) Pub. No.: US 2014/0209617 A1
(43) Pub. Date: Jul. 31, 2014

(54) Method of manufacturing a container, container and apparatus for manufacturing a container

(71) Applicant: Pawel Sumorowski, Zarki (PL)

(72) Inventor: Pawel Sumorowski, Zarki (PL)

(21) Appl. No.: 14/154,280

(22) Filed: Jan. 14, 2014

(30) Foreign Application Priority Data
Jan. 31, 2013 (EP) 13461503.8

(51) Int. Cl. B29C 41/08; B65F 1/14

(52) U.S. Cl. CPC B29C 41/085; B65F 1/14
USPC 220/567.1; 264/154; 425/305.1

(57) ABSTRACT

A container having the shape of a cylinder of a substantially horizontal symmetry axis, closed at its both ends with the bottoms comprising steps in which a body having the form of a pipe empty inside of a corrugated inner surface is manufactured so that a first set of spray nozzles arranged at various angles is introduced into a mold turning around its own axis and then an inner surface of the mold is sprayed, next a hole is cut out for an inspection manhole in the surface of the produced body, then the body is closed with the bottoms at both ends so that a bottom mold is placed at each open end of the body, a second set of spray nozzles arranged at various angles is introduced through the hole for an inspection manhole, and then an inner surface of the bottom mold is sprayed.

### BACKGROUND

The subject matter of the application is a method of manufacturing a container, a container and apparatus for manufacturing a container, especially a container substantially for sewage, having the shape of a cylinder of a substantially horizontal symmetry axis, closed at its both ends with the bottoms, a method of manufacturing such a container and an apparatus for manufacturing such a container.

In the prior art it is known a method of manufacturing containers for sewage, where a first layer of thick resin—e.g. gelcoats is applied by means of a roller onto a paste coated mold having the shape of a half hollow cylinder, then after hardening of the gelcoat, a few layers of glass fibers mats are alternately applied, the mats being soaked with fluid polyester resin and rolled out to shape the mold. Then the two obtained halves of a container are glued together with the use of resin with the glass fibers, glue unevennesses are leveled, and then inside the obtained container along the joint a strip of the width of about 30 cm is glued which reinforces the joint of the two halves of the container.

In the prior art it is known a method of manufacturing containers for sewage by spraying a mold by means of a single spray nozzle (FIG. 1). The spray nozzle according to the method is positioned at a distance of about 50 cm above the surface of a mold and the width of the spraying stream amounts to 60°. The method may only be applied in the case of containers of even surface, because in the case of uneven surface the sprayed material is spread irregularly.

In the prior art there are known sewage containers manufactured of glass-polyester laminate i.e. polyester resin reinforced with glass fibers.

U.S. Pat. No. 4,363,687 A discloses a method of manufacturing a container having the shape of a cylinder of a substantially horizontal symmetry axis, closed at its both ends with the bottoms, characterized in that it comprises steps in which a body having the form of a pipe empty inside, and of a flat outer wall. The container is manufactured with the use of a form with external corrugated reinforcements and flat inner surface. The container is manufactured so that a spray nozzle is introduced into a turning around its own axis mold and then an inner surface of the mold is sprayed with a mixture of resins and fibers.

EP 1 533 252 A2 discloses a multi-chamber container having a shape of a cylinder of a substantially horizontal symmetry axis, closed at its both ends with the bottoms, characterized in that a body of a container has a form of a pipe of a corrugated wall with clearly visible joints between all chambers.

From the specification of the Polish Utility Model No. 58780 it is known a container for collecting sewage having the shape of a tank of elliptical cross-section, the ratio of the horizontal and vertical diameter equals to 9:7, the outer surface of the container is corrugated, whereas the notches at half of the side surface of the container both of the top and of the bottom, transform to an even surface, and then transform to short protrusions positioned at the angle of 90°. Side walls of the container are slightly rounded and reinforced with profiled swellings. The container consists of two parts, joined with each other along protrusions located in a horizontal plane of the container around its whole circumference.

### SUMMARY OF THE INVENTION

The container consists of two parts, which are glued together in order to obtain a fixed joint of the parts. The container is made of polyester resins reinforced with mats made of glass fibers by means of appropriately profiled molds.

Application of such a solution where a container consists of two parts joined with each other e.g. by gluing causes that the strength of the container is decreased as in the case of high loads the container may get unstuck at the joint. For example in the case of improper pouring of the ground under the lower part of the container, the ground lying on the upper part of the container will deposit on the protrusions situated on the horizontal plane of the container around its whole circumference instead of subsiding down the container, as a result of it in the case of high loads the container may get unstuck.

Method of manufacturing a container having the shape of a cylinder of a substantially horizontal symmetry axis, closed at its both ends with the bottoms according to the invention comprises steps in which a body having the form of an empty inside pipe having corrugated inner surface is manufactured so that a first set of spray nozzles arranged at various angles is introduced into a mold which is turning around its own axis, and then an inner surface of the mold is sprayed with a mixture of resins and fibers. Next, a hole is cut out for an inspection manhole in the surface of the produced body, then the body is closed with the bottoms at both ends so that a bottom mold is placed onto each open end of the body, a second set of spray nozzles arranged at various angles is introduced through the hole for an inspection manhole, and then an inner surface of the bottom mold is sprayed with a mixture of resins and fibers.

Preferably before spraying the mold with a mixture of resins and fibers, the inner surface of the mold is sprayed with a mixture of resins. Also preferably before placing the bottom mold on the body, an inner surface of the bottom mold is sprayed with a mixture of resins.

Moreover preferably the mixture of resin and fibers contains from 40% to 70% of resin and from 30% to 60% of fiber. The resin is chosen from among polymer resins, polyester resins, epoxy resins, phenol-formaldehyde resins, urea-formaldehyde resins, whereas the fiber is chosen from natural, glass, synthetic, polymer, polyester, polypropylene, polyamide and carbon fibers. The temperature of the sprayed mixture of resins and fibers lies in the range from 0° C. to 40° C. and moreover the mixture contains additionally fillers and pigments.

A container according to the invention having the shape of a cylinder of a substantially horizontal symmetry axis, closed at its both ends with the bottoms, is characterized in that a body of a container has the form of a pipe of a corrugated continuous wall. The bottoms are joined with the body of the container in the form of an overlap, and the joint is sealed with a layer of resins and fibers mixture. The container is made of a mixture of resins and fibers.

Apparatus for manufacturing a container having the shape of a cylinder of a substantially horizontal symmetry axis closed at its both ends with the bottoms comprises a turning round its own axis mold having the shape of a cylinder of a substantially horizontal symmetry axis, a first movable set of spray nozzles arranged at various angles connected to a tank for a mixture of resins and fibers, a hole cutting unit, a second movable set of spray nozzles arranged at various angles connected to a tank for a mixture of resins and fibers, movable bottom molds.

Preferably the mold consists of two parts, which have the form of half hollow cylinders of a corrugated inner surface.

Also preferably the mold is composed of plurality of pipe segments of a corrugated inner surface, the segments being joined with each other.

The advantage of a container according to the invention is its higher strength for loads and resistance to getting unstuck which is provided by the corrugated continuous side wall of the body. The advantage of the method of manufacturing the container according to the invention is decreasing the amount of material needed for manufacturing a container, and thereby decreasing the weight of a container and enabling decreasing the thickness of the walls and at the same time improving the strength.

### BRIEF DESCRIPTION OF THE DRAWING

The invention is closer presented in the preferable embodiment in the drawing in which:

FIG. 1 presents a known method of manufacturing a container according to the invention;

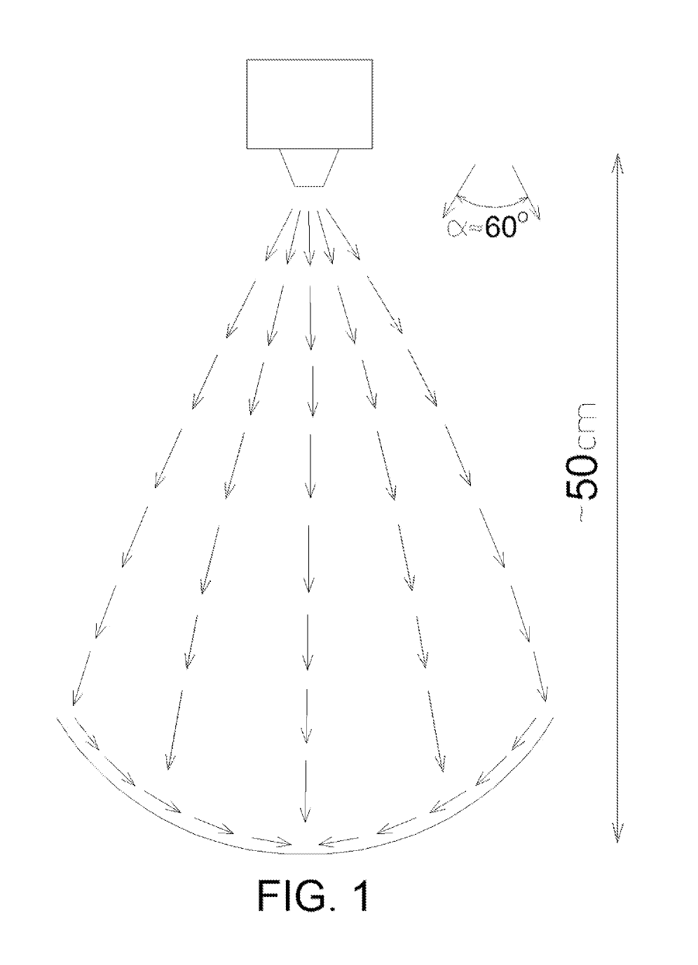

FIG. 2 presents a container according to the invention in a perspective view;

FIG. 3 presents a first set of spray nozzles arranged at various angles;

FIG. 4 presents arrangement of spray nozzles of the first set of spray nozzles in relation to an inner surface of a mold in a plan view.

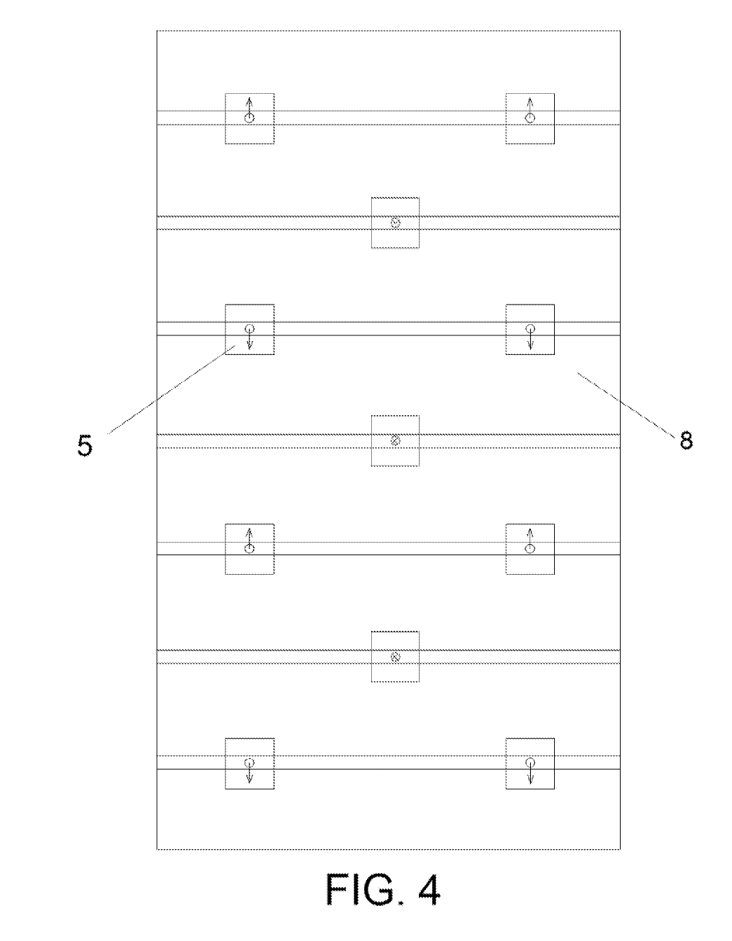

### DETAILED DESCRIPTION

A method of manufacturing a container 1 having the shape of a cylinder of a substantially horizontal symmetry axis, closed at its both ends with the bottoms 3A, 3B according to the first embodiment consists in that in the first step a body 2 having the form of a corrugated pipe empty inside is manufactured.

The body 1 is manufactured e.g. by means of a metal mold 7 consisting of two identical parts, which after putting the parts together has a form of a hollow cylinder of a substantially horizontal symmetry axis, having corrugated inner surface 8 and open ends. Nonetheless it is possible to use sets of segments of a pipe of a corrugated inner surface made of plastic, joined with each other as a mold 7, whereas the segments may be made of a mixture of resins and fibers. In such a case the mold 7 is produced from segments of a pipe arranged in relation to each other so as to form a hollow cylinder of a substantially horizontal symmetry axis having a corrugated inner surface 8 and open ends, whereas the mold produced in such a manner will then constitute a part of a ready-made container 1. The mold 7 produced of a set of pipe segments joined with each other is fixed in an additional outer fixing system.

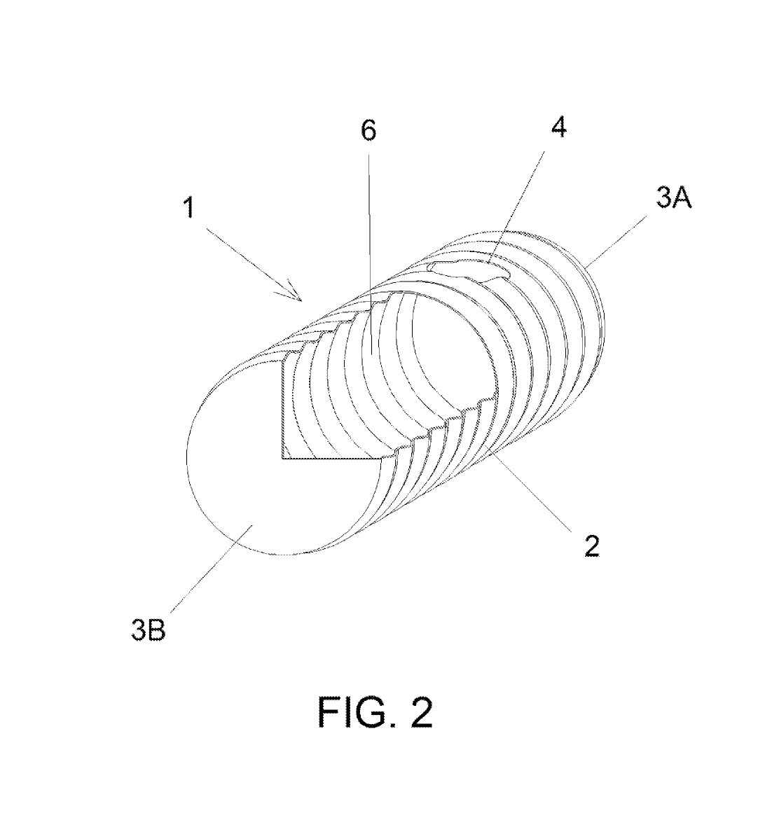

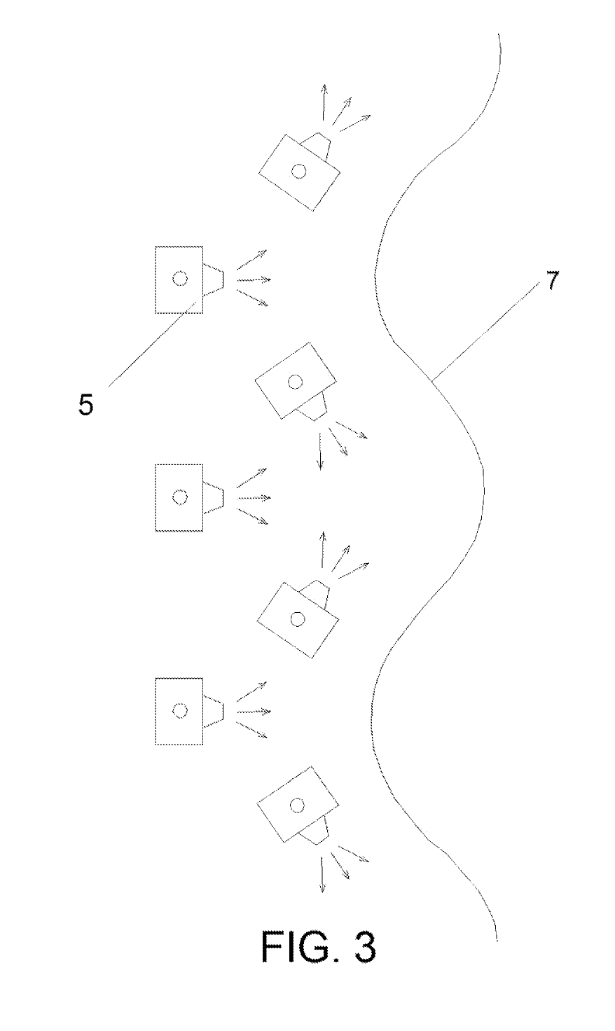

Into the interior of the mold 7 rotating around its own axis, through its open end a first set of spray nozzles 5 arranged at various angles (FIG. 2) is introduced, which are mounted on guides fixed on a rigid arm and nozzles 5 being positioned alternately perpendicularly and at angles in relation to the inner surface 8 of the mold as it is shown in FIG. 3. Spray nozzles 5 are arranged at various angles in order not to allow the applied mixture to flow down by gravity into concavities of the corrugated surface of the mold 7. The first set of spray nozzles 5 arranged at various angles is connected to a supply unit for feeding the mixture. Then the inner surface 8 of the mold 7 is sprayed with the mixture of resins and fibers by carrying the first set of nozzles 5 perpendicularly to the inner surface 8 of the mold 7 at a distance of about 15 cm from the surface. According to such a method a body 2 of integral inner structure of a corrugated surface 6 is produced, the body characterized by high strength. However before spraying the inner surface 8 of the mold 7 with a mixture of resins and fibers, it is also possible to spray the inner surface 8 of the mold 7 with a mixture of resins e.g. gelcoate, which additionally protects and provides visible uniformity of the surface of the container 1.

The mixture of resins and fibers used for spraying the mold consists of about 60% of polymer resin and about 40% of glass fibers. Other plastic fibers or natural material fibers e.g. flax fibers, polyester fibers may be used instead of glass fibers. In the process of spraying, the mixture is delivered at the temperature of 0° C. to 40° C.

In the second step of the method according to the first embodiment, after cooling the mold 7 is split in half in order to take the ready-made body 2 of the container 1 out of the mold 7 or in the case of the mold 7 produced from pipe segments, it is taken out of the fixing system, and then in the surface of the body 2 of the container 1 a hole 4 for an inspection manhole is cut out by means of a hole cutting unit. The hole cutting unit may consist of e.g. a hole saw and a drill.

Next in the last step of the method of manufacturing the container 1, the body 2 of the container 1 having the shape of a pipe empty inside is closed at its both ends with the bottoms 3A, 3B. For this purpose a bottom mold is placed at each open end of the body 2 and then through the hole 4 for an inspection manhole a second set of spray nozzles 5 arranged at various angles connected to a supply unit for feeding a mixture of resins and fibers is introduced. Then the inner surface of the bottom mold is sprayed with a mixture of resins and fibers, whereas in order to obtain a sealed connection of the bottoms 3A, 3B with the body 2 the spraying is effected in such a manner that a layer of the sprayed mixture of resins and fibers overlaps the edges of the body 2 which touch the bottom 3A, 3B (so called overlap). Nevertheless before placing the bottom mold on the body 2, it is possible to spray the inner surface of the bottom mold with a mixture of resins.

The mixture of resins and fibers used for spraying the bottom mold consists of about 60% polymer resin and about 40% of glass fibers. Also in this manufacturing process other materials and compositions may be used. Appropriately the mixture is supplied at the temperature of 0° C. to 40° C.

A container 1 according to the invention is made of a mixture of resins and fibers and has the shape of a hollow cylinder of a substantially horizontal symmetry axis, closed with the bottoms 3A, 3B at its both ends, whereas the body 2 of the container 1 has the form of a pipe of a continuous wall of a corrugated inner surface 6. The bottoms 3A, 3B are joined with the body 2 of the container 1 in an overlapping manner, and the joint is sealed on the inner side with a layer of resins and fibers. Moreover in the body 2 of the container 1 there is a hole 4 for an inspection manhole.

An apparatus for manufacturing the container 1 according to the first embodiment comprises a rotating around its own axis mold 7 having the shape of a cylinder of a substantially horizontal symmetry axis and a corrugated inner surface 8, whereas the mold 7 consists of two parts which have the form of half hollow cylinders.

Moreover, the apparatus according to the first embodiment comprises a first set of spray nozzles 5 arranged at various angles and fixed on guides placed on a rigid arm, whereas the spray nozzles 5 are connected to a supply unit for feeding a mixture of resins and fibers. The apparatus according to the first embodiment comprises also movable bottom molds, a second movable set of spray nozzles 5 connected to a supply unit for feeding a mixture of resins and fibers and a unit for cutting out holes such as a hole for an inspection manhole.

An apparatus for manufacturing a container 1 according to the second embodiment comprises a rotating around its own axis mold 7 having the shape of a cylinder of a substantially horizontal axis and a corrugated inner surface 8, whereas the mold 7 consists of a set of pipe segments connected with each other, fixed in an apparatus by means of an additional external fixing system. In this embodiment the applied mold 7 is made of plastic, which later on will constitute an integral part of the container manufactured according to this method. In such a case the mold 7 made of plastic is mounted in the apparatus for manufacturing the container 1 by means of an additional external fixing system, which enables handling the mold 7 in the process of manufacturing. Moreover, the apparatus according to the second embodiment comprises a first movable set of spray nozzles 5 arranged at various angles and fixed on guides placed on a rigid arm, whereas spray nozzles 5 are connected to a tank for a mixture of resins and fibers. The apparatus according to the second embodiment comprises also movable bottom molds, a second movable set of spray nozzles 5 connected to a tank for the mixture of resins and fibers and a unit for cutting out holes such as e.g. a hole for an inspection manhole.

1. A method of manufacturing a container having the shape of a cylinder of a substantially horizontal symmetry axis, closed at its both ends with the bottoms, the method comprises the steps of:
a body (2) having the form of a pipe empty inside of a corrugated inner surface (6) is manufactured so that
a first set of spray nozzles (5) arranged at various angles is introduced into a turning around its own axis mold (7) and then
an inner surface (8) of the mold (7) is sprayed with a mixture of resins and fibers,
next
a hole (4) is cut out for an inspection manhole in the surface of the produced body (2), then
the body (2) is closed with the bottoms (3A, 3B) at both ends so that
a bottom mold is placed onto each open end of the body (2),
a second set of spray nozzles (5) arranged at various angles is introduced through the hole (4) for an inspection manhole, and then
an inner surface of the bottom mold is sprayed with a mixture of resins and fibers.

2. The method according to claim 1, wherein before spraying the mold (7) with a mixture of resins and fibers, the inner surface (8) of the mold (7) is sprayed with a mixture of resins.

3. The method according to claim 2, wherein before placing the bottom mold on the body 1, an inner surface of the bottom mold is sprayed with a mixture of resins.

4. The method according to claim 1, wherein the mixture of resin and fibers contains from 40% to 70% of resin and from 30% to 60% of fiber.

5. The method according to claim 1, wherein the resin is chosen from the set consisting of polymer resins, polyester resins, epoxy resins, phenol-formaldehyde resins, and urea-formaldehyde resins.

6. The method according to claim 1, wherein the fiber is chosen from the set consisting of natural fibers, glass fibers, synthetic fibers, polymer fibers, polyester fibers, polypropylene fibers, polyamide fibers, and carbon fibers.

7. The method according to claim 1, wherein temperature of the sprayed mixture of resins and fibers is in the range from 0° C. to 40° C.

8. The method according to claim 1, wherein the mixture contains additionally fillers and pigments.

9. A container with a single chamber having a shape of a cylinder of a substantially horizontal symmetry axis, closed at its both ends with the bottoms, a body (2) of a container (1) has a form of a pipe of a corrugated continuous wall, wherein the bottoms are connected with the corrugated continuous wall in an overlapping manner and sealed by spraying a mixture of resins and fibers on an inner surface of the bottom mold and on an inner surface of corrugated continuous wall, and the mixture of resins and fibers is applied by the spray nozzles (5) arranged at various angles and introduced through the hole (4) for an inspection manhole.

10. The container according to claim 9 wherein the container (1) is made of a mixture of resins and fibers.

11. An apparatus for manufacturing a container having the shape of a cylinder of a substantially horizontal symmetry axis closed at its both ends with the bottoms, the apparatus comprising:
a mold (7) having a shape of a cylinder of substantially horizontal symmetry axis, turning round its own axis;
a first movable set of spray nozzles (5) arranged at various angles connected to a tank for a mixture of resins and fibers;
a hole cutting unit;
a second movable set of spray nozzles (5) arranged at various angles connected to a tank for a mixture of resins and fibers;
movable bottom molds.

12. The apparatus according to claim 11, wherein the mold (7) consists of two parts, each of which has the form of a half hollow cylinder of a corrugated inner surface (8).

13. The apparatus according to claim 11, wherein the mold (7) is composed of plurality of segments of a pipe of a corrugated inner surface (8), the segments being joined with each other.
